(19) United States
(12) Patent Application Publication
(10) Pub. No.: US 2007/0205997 A1
(43) Pub. Date: Sep. 6, 2007

(54) Controlling A Visual Display By Bending

(75) Inventors: Pieter Van Lieshout, Beek En Donk (NL); Edzer Huitema, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/599,255

(22) PCT Filed: Mar. 24, 2005
(86) PCT No.: PCT/IB05/51024

§ 371 Date: Sep. 23, 2006

Related U.S. Application Data
(60) Provisional application No. 60/557,275, filed on Mar. 29, 2004.

(51) Int. Cl. G09G 5/00

(52) U.S. Cl. 345/204

(57) ABSTRACT

A method and apparatus are provided for controlling a visual display 16 on a display panel 12 by applying a bending force 18 to the display panel 12. The bending force 18 is detected, and the visual display 16 is modified in accordance with a predetermined relationship between the bending force 18 and the visual display 16. The bending force 18 may generate a torque on the display panel 12 that is detected and utilized for modifying the visual display 16 in accordance with a predetermined relationship between the detected torque and the visual display 16.

This invention relates to portable electronic devices having a display panel for displaying a visual display, and more particularly to controlling the visual display through application of bending force to the display panel.

Modem electronic devices, such as computers, or personal data assistants (PDA), include a relatively thin display panel for viewing a visual display produced by the electronic device. In some computers, for instance, display panel is removable from the computer for operation as a tablet-like input/output device and display. Some computers are even produced in a tablet-like form, including a central processing unit (CPU) and a touch sensitive screen that can be written on with a stylus for inputting drawings or text to the computer. Tablet-like display panels sometimes include traditional control devices such as buttons, joysticks, thumbwheels, and touch pads, for controlling the image displayed on the display panel, inputting data, and moving cursors that are provided as part of the visual display.

In some of these electronic devices, the display panel is flexible, and can be rolled into an elongated stick-like tubular housing when not in use. This approach is disclosed in United States Patent Application Publication US 2002/0070910 A1, to Fujieda, et al., PCT Publication WO/01/50232, to Zhang, et al, and PCT Publication WO 98/03962, to Johnson, et al.

Thin, tablet-like display panels create opportunities for advantageously and intuitively controlling the image displayed on the display panel, inputting data, and moving cursors that are provided as part of the visual display, in ways that have not previously been utilized.

This invention provides a method and apparatus for controlling a visual display on a display panel by applying a bending force to the display panel.

In one form of the invention, the bending force is detected and the visual display is modified in accordance with a predetermined relationship between the bending force and the visual display. The bending force may generate a torque on the display panel that is detected and utilized for modifying the visual display in accordance with a predetermined relationship between the detected torque and the visual display.

The display panel may also include a control device for modifying the predetermined relationship between the bending force and the visual display. Conversely, the display panel may also include a control device for receiving an input for modifying the visual display according to a predetermined relationship between the input applied to the control device and the visual display, and the predetermined relationship between the input applied to the control device and the visual display may be modified in accordance with the bending force applied to the display panel.

The display panel may have a substantially rigid form. The display panel may alternatively be provided in a form that includes a housing and a stowable display screen that may be rolled up into and stowed within a housing, with the housing extending along and attached to an edge of the stowable display screen.

The visual display may include a movable cursor that is movable in accordance with a predetermined relationship between the bending force and the visual display. The visual display may be scrollable in accordance with a predetermined relationship between the bending force and the visual display. The visual display may include a page up/down mode in which the visual display is caused to page up and/or down in accordance with a predetermined relationship between the bending force and the visual display.

Utilizing bending force for controlling the display, according to the invention, results in achieving control in a manner that may be far more intuitive, and similar to the process that one would use to leaf through the pages of a multi-page printed document. The invention also provides a method and apparatus for controlling a visual display on a display panel in a manner that is more amenable than prior thin-panel displays, to operation in a crowded environment, such as a commuter train, or while a person utilizing a display panel according to our invention while standing or walking.

The foregoing and other features and advantages of the invention will become further apparent from the following detailed description of exemplary embodiments, read in conjunction with the accompanying drawings. The detailed description and drawings are merely illustrative of the invention rather than limiting, the scope of the invention being defined by the appended claims and equivalents thereof.

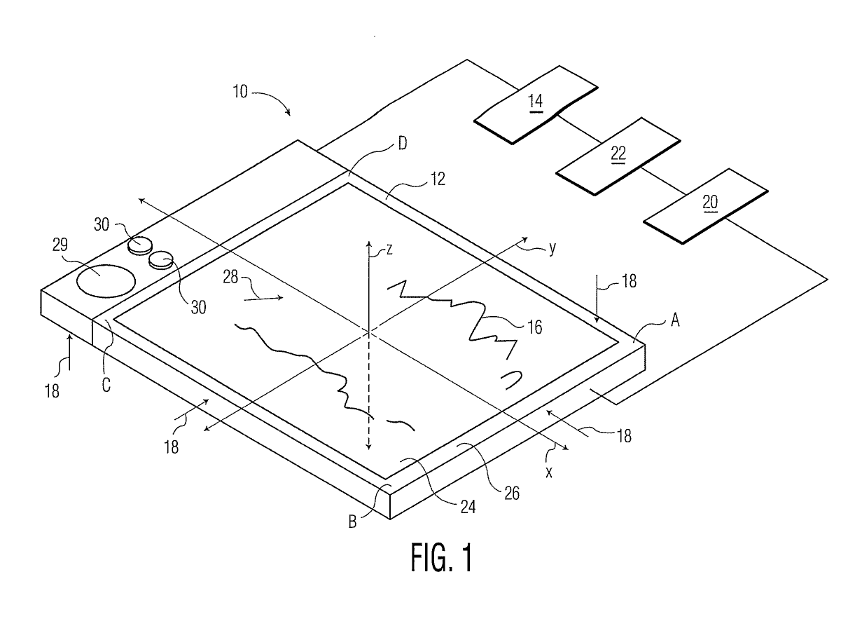

FIG. 1 is a perspective view of a first exemplary embodiment of a portable electronic device, according to the invention, including a relatively rigid display panel;

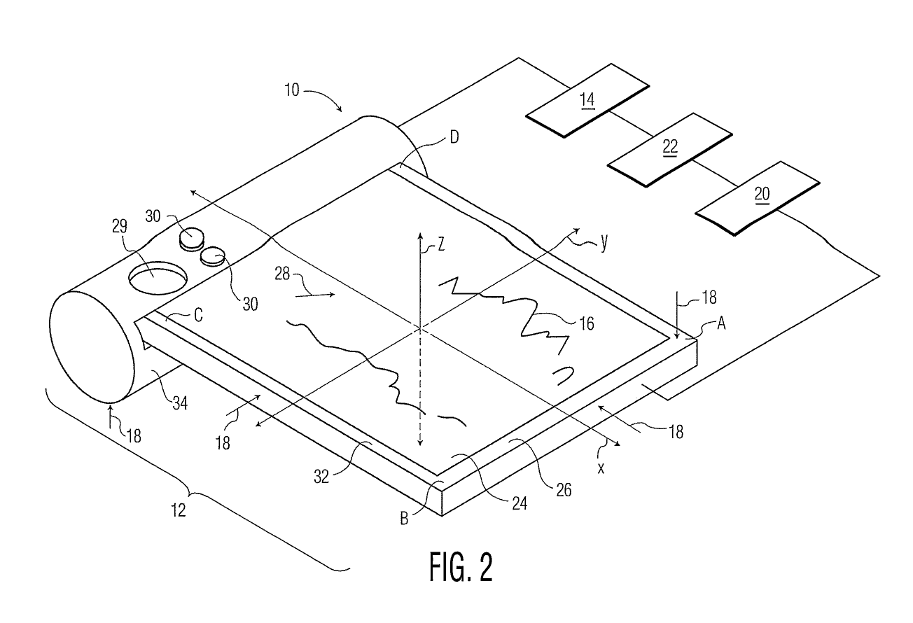

FIG. 2 is a perspective view of a second exemplary embodiment of a portable electronic device, according to the invention including a display panel having a flexible display screen that may be rolled-up and stored within a housing attached to the display screen;

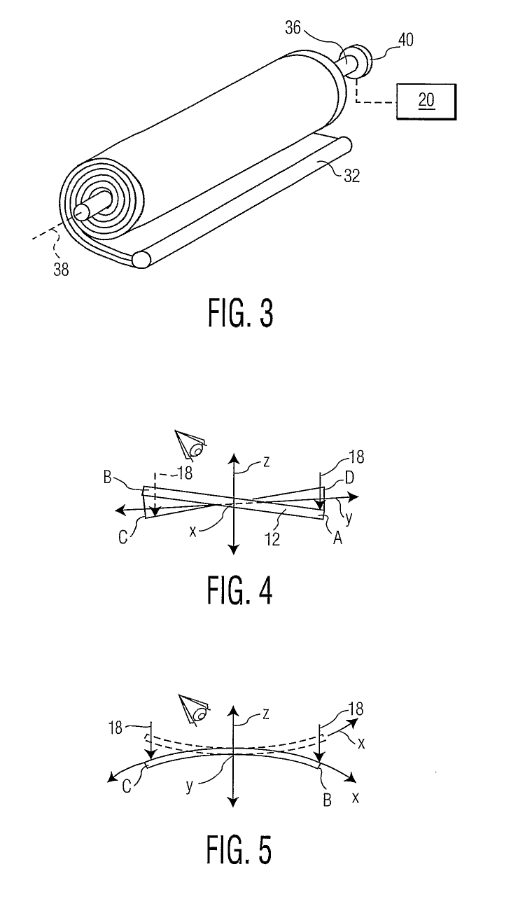

FIG. 3, is a partial perspective view of the portable electronic device of FIG. 2, showing the flexible display screen rolled-up around a roller; and

FIGS. 4-8 are schematic representations of bending forces applied to display panels, according to the invention, with resulting deflections exaggerated for illustrative purposes.

Throughout the following description of exemplary embodiments of the invention, components and features that are substantially equivalent or similar will be identified in the drawings by the same reference numerals. For the sake of brevity, once a particular element or function of the invention has been described in relation to one exemplary embodiment, the description and function will not be repeated for elements that are substantially equivalent or similar in form and/or function to the components previously described, in those instances where the alternate exemplary embodiments will be readily understood by those skilled in the art from a comparison of the drawings showing the various exemplary embodiments in light of the description of a previously presented embodiment.

FIG. 1 shows a first exemplary embodiment of the invention, in the form of a portable electronic device 10 including a display panel 12, a processor 14 for generating a visual display 16 on the display panel 12, and an apparatus for controlling the visual display 16 on the display panel 12 in response to one or more bending forces, as indicated by arrows 18, applied to the display panel 12.

The apparatus for controlling the visual display 16, in the exemplary embodiment, includes the display panel 12, a detector 20 operatively attached to the display panel 12 for detecting the bending forces 18 applied to the display panel 12, and a controller 22. The controller 22 is operatively connected to the detector 20 and the display panel 12, for receiving a signal from the detector 20 that is indicative of the bending forces 18 applied to the display panel 12, and modifying the visual display 16 in accordance with a predetermined relationship between the detected bending forces 18 and the visual display 12.

As used herein, the term bending force indicates a force applied to the display panel 12 that would tend to generate a bending or deforming response in the display panel 12, whether or not perceptible bending or deformation of the display panel 12 actually occurs. The bending force 18 of the invention may or may not be applied to a display screen 24 of the display panel 12 bearing the visual display 12, and is intended to denote a force different from the type of force applied in the past to touch sensitive display screens for actuating embedded or virtual push buttons, or stylus actuated drawing functions, of a display panel. For example, the bending force 18 may be applied to a frame 26 that forms the peripheral edges of the display screen 24 of the display panel 12.

One or more bending forces 18 may also be applied to the visual display 12 in a manner that generates a torque on the display panel 12. The detector 20, in some embodiments of the invention, detects this torque and modifies the visual display in accordance with a predetermined relationship between the detected torque and the visual display 16.

The predetermined relationship between the detected bending force 18, or torque, and the visual display 16 preferably includes a provision for modifying the visual display 16 as a function, not just of the presence of the detected bending force 18, or torque, but also of the magnitude of the detected bending force 18, or torque. As the bending force 18, or the torque on the display panel 12 is increased or decreased, for example, the speed or extent of the modification of the visual display will also preferably increase or decrease proportionately.

The visual display 16 of the exemplary embodiment includes a movable cursor 28. In one operational mode, the controller 22 of the exemplary embodiment modifies the visual display 16 by moving the cursor 28 in accordance with a predetermined relationship between the detected bending force 18, or the torque generated by the bending force 18, and the visual display 16.

In another operational mode of the exemplary embodiment, the visual display 16 is scrollable, and the controller 22 modifies the visual display 16 by scrolling the visual display 16 in accordance with a predetermined relationship between the detected bending force 18, or detected torque, and the visual display 16. The visual display 12 of the exemplary embodiment also includes a page up/down mode, in which the controller modifies the visual display 16 by paging up/down in accordance with a predetermined relationship between the detected bending force 18, or torque, and the visual display 16.

The display panel 12 of the exemplary embodiment includes one or more control devices, such as a traditional touch pad 29, and buttons, wheels, or joysticks 30, for selecting a particular operating mode of the display panel 12 and/or for modifying the predetermined relationship between the bending force 18, or torque, and the visual display 16. Conversely, in other embodiments, the control devices 29, 30 may function as the primary means of receiving an input for modifying the visual display 16, according to a predetermined relationship between the input applied to the control device 29, 30 and the visual display 12, with the controller 22 modifying the predetermined relationship between the input applied to the control device 29, 30 and the visual display 16 in accordance with the bending force 18, or torque, applied to the display panel 12.

Although the processor 14, controller 22 and detector 20 are shown schematically in FIG. 1 as being located outside of the display panel 12, it is contemplated that it will generally be advantageous for these elements 14, 22, 20 to be a part of the display panel 12. In some embodiments, however, such as a computer having a detachable screen coupled to a central processing unit, through a wireless link, an infra-red link, or an umbilical cable, for example, it may be desirable to have the processor 14, controller 22, and detector 20 located at least partially in the central processing unit, remote from the display panel 12.

FIG. 2 shows a second exemplary embodiment of a portable electronic device 10, that is generally identical to the first exemplary embodiment, except that the display panel 12 in the second embodiment includes a stowable display screen 32, which may be rolled-up into, and stowed within a housing 34 that extends along and is attached to the left edge (as depicted) of the stowable display screen 32.

As shown in FIG. 3, the stowable display screen 32 may include an axle or roller 36, which is attached to the stowable display screen 32 for receiving the display screen 32 as it is rolled up into the housing 34. The roller 36 rotates about an axis 38 as the display screen 32 is rolled in to or out of the housing 34. Where the visual display includes a roller 36, the detector 20 may include a sensor 40 operatively connected to the roller 36 for detecting a reaction on the roller 36 resulting from application of the bending force 18, or torque, to the display panel 12, with the controller 22 modifying the visual display 16 in accordance with a predetermined relationship between the detected reaction on the roller 36 and the visual display 16.

FIGS. 4-8 depict several examples of the many ways that bending forces 18 may be applied to the display panel 12. In these examples, the forces 18 are applied to the rectangular shaped display panel 12, as shown in FIGS. 1 and 2, along one or more orthogonal axes x, y, z, as shown in FIGS. 1 and 2. For purposes of illustration, the axes are oriented with the x and y axes lying in a plane defined by a viewing surface of the display screen 24, and the z axis extending orthogonally through the plane defined by the viewing surface of the display screen 24, at the intersection of the x and y axes. In the examples of FIGS. 1 and 2, and 4 through 8, the x axis is oriented horizontally between a right edge of the display screen 24, extending from a right upper corner A to a lower right corner B of the display screen 24, and a left edge of the display screen 24, extending from an lower left hand corner C to an upper left hand corner D of the display screen 24. A person grasping the right edge A-B of the display panel 12 in their right hand, and the left edge C-D of the display screen 24 in their left hand would be viewing the visual display 16 generally along the z axis. It will be understood, however, by those having skill in the art, that a display panel 12, according to the invention, may have a non-rectangular shape, with or without corners, and may utilize a coordinate system other than the one depicted for purposes of explanation, in FIGS. 1 and 2, and 4 through 8. The display panels 12 of FIGS. 1 and 2 might also be oriented, for example, for operation turned 90 degrees, to be grasped along a top and bottom edge of the display panel 12.

It should be noted that the deflections shown in FIGS. 4 through 8, caused by the bending forces 18, are greatly exaggerated for illustrative purposes. While it is certainly contemplated, within the scope of the invention, for embodiments of the invention having flexible display screens, that the display panel 12 might actually flex to the extent shown in FIGS. 4-8, in many embodiments of the invention the actual deflection of the display device caused by application of the bending forces 18, or torques, will be negligible. FIG. 4 shows the display panel 12 being subjected to a twisting torque, generated by a pair of bending forces 18 applied at diagonally opposite corners A and C. This condition might occur, for example, if a person grasping the right and left edges A-B, C-D of the display panel 12 with their right and left hands, respectively, were to rotate their wrists in a way that applied a torque to the right side of the display panel 12 tending to rotate the upper right corner A downward about the x axis and the lower right corner B upward about the x axis, while simultaneously applying a torque to the left side of the display panel 12 that would tend to rotate the lower left corner C downward about the x axis and the upper left corner D upward about the x axis. Such a twisting torque might be useful, for example, as an intuitive motion for moving the cursor 28 in one direction across the display screen 24, with a twisting torque in the opposite direction being used for moving the cursor 24 in an opposite direction.

FIG. 5 shows, in solid lines, the display panel 12 being subjected to a bending torque, generated by a pair of bending forces 18, both applied in a downward direction, along the right and left edges A-B, C-D of the display panel 12. This condition might occur, for example, if a person grasping the right and left edges A-B, C-D of the display panel 12 with their right and left hands, respectively, were to rotate their wrists in a way that applied a torque to the right side of the display panel 12 that would tend to move both the right and left edges A-B, C-D downward, in opposite directions about the y axis, with the result that the middle of the display panel would tend to be bent convexly upward, toward the person viewing the visual display, with respect to the edges A-B, C-D. Such a bending torque might be useful, for example, as an intuitive motion for causing a scrolling or page forward modification of the visual display 16 across the display screen 24, with a bending torque in the opposite direction causing a scrolling or page back modification of the visual display 16. It will be appreciated that such a bending torque initiated scrolling or paging function would involve very much the same hand and wrist motions that are involved in paging forward or back through a bound printed book or document, and would thus be highly intuitive to a person using the display panel 12.

FIGS. 6 through 8 show bending forces 18 applied to the display panel 12 in directions lying generally within a plane defined by the x and y axes.

In FIG. 6, oppositely directed bending forces 18, acting parallel to the x axis, are applied to the upper right and upper left corners A, D of the display panel 12, in a manner that would tend to cause the upper edge A-D of the display panel 12 to be compressed with respect to the lower edge B-C of the display panel 12. Although no torque is generated with this application arrangement, the forces 18 can be detected by the detector 20 and used for modifying the visual display 16 in a desired manner. Such an application of bending forces 18 might be used, for example, to intuitively trigger a zoom in function, with application of similarly directed bending forces 18 at the lower corners B, C of the display panel 12 being used for intuitively triggering a zoom out function. Alternatively, the direction of the bending forces 18 as shown in FIG. 6 might simply be reversed, so that the bending forces 18 are opposing one another in tension, to intuitively trigger a zoom out function.

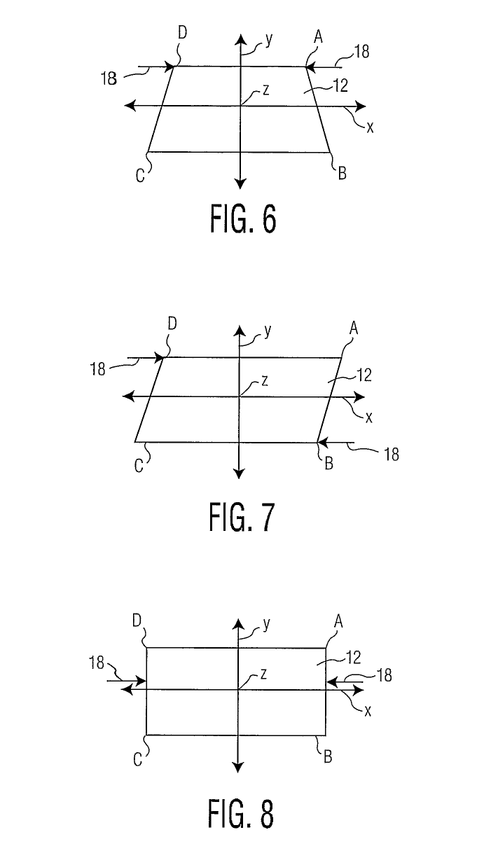

In FIG. 7, oppositely directed forces acting parallel to the x axis are applied to the upper left and lower right corners D, B of the display panel 12, in a manner that generates a planar torque tending to cause display panel 12 to deflect into a parallelogram-like shape. The planar torque generated by this application of bending forces 18 is intuitively similar to rotating the display panel, about the z axis, and might be used, for example to cause the visual display 16 to rotate on the display screen 24. Such a planar torque would also be intuitively similar in feel to applying a steering force to a steering wheel, or could be used for causing the cursor 28 to move in one direction or the other across the visual display 16.

FIG. 8 shows an application of opposing bending forces 18 acting generally along the x axis, rather than parallel to the x axis, as was the case for the application of bending forces 18 shown in FIG. 6 and described above. Such an application of bending forces might be used for intuitively triggering the same functions described above with regard to FIG. 6, or perhaps as an intuitive command for closing a document, because the feel would be very much the same as closing a book.

It is contemplated that the detector 20 in any embodiment of the invention may include force or torque sensing elements of any appropriate type, such as strain gages, load cells, piezoelectric devices, Hall-effect sensors, etc., embedded in the display panel 12, or attached to components of the display panel 12, such as the roller 36 of the second exemplary embodiment shown in FIGS. 2 and 3 above. Preferably, these force and torque sensing elements, together with the detector, will be capable of discerning the magnitude of the applied force or torque, in addition to the presence of the applied force or torque.

In some forms of the invention, application of the bending force 18 to the display panel 12 may result in generating a net torque on the display panel 12 that includes one or more of a twisting torque component, a bending torque component, a planar torque component, as described above, and may even further include other torque or bending force components. It is contemplated that in some embodiments of the invention, the display panel 12 will discern these separate torque and bending force components, and modify the visual display 16 in accordance with a predetermined relationship between one, or more, of the discerned separate components. It is also contemplated that the predetermined relationship may include a prioritization of the various discerned components, or that the display panel 12 may allow a person using the display panel 12 to select or exclude one or more of the discerned components as the input to be utilized for modifying the visual display 16. In the exemplary embodiments of the electronic device 10 shown in FIGS. 1 and 2, for example, such a selection could be made using the control devices 29, 30 to select a particular mode of operation.

Those having skill in the art will recognize that, although the invention has been described herein in relation to certain exemplary embodiments, many other variations and embodiments are possible. For example, it is contemplated that the invention may be used in conjunction with display panels 12 having sensors or control devices 30 for detecting stimuli such as motion, heat or sound applied to the display panel 12. It is also contemplated that the invention may be utilized in conjunction with functional modes, such as automatically formatting the visual display 16 to fit on only the unrolled portion of the stowable screen 32. The scope of the invention is not limited, therefore, to the specific exemplary embodiments described above. All changes or modifications within the meaning and range of equivalents are intended to be embraced herein.

1. A method for controlling a visual display 16 on a display panel 12 by applying a bending force 18 to the display panel 12.

2. The method of claim 1 further comprising detecting the bending force 18 and modifying the visual display 16 in accordance with a predetermined relationship between the bending force 18 and the visual display 16.

3. The method of claim 2 wherein the display panel 12 includes a control device 30 for modifying the predetermined relationship between the bending force 18 and the visual display 16, and the method further comprises modifying the predetermined relationship between the bending force 18 and the visual display 16.

4. The method of claim 2 wherein the display panel 12 includes a control device 30 for receiving an input for modifying the visual display 16 according to a predetermined relationship between the input applied to the control device 30 and the visual display 16, and the method further comprises modifying the predetermined relationship between the input applied to the control device 30 and the visual display 16 in accordance with the bending force 18 applied to the display panel 16.

5. The method of claim 1 further comprising:
generating a torque on the display panel 12 through application of the bending force 18;
detecting the torque; and
modifying the visual display 16 in accordance with a predetermined relationship between the detected torque and the visual display 16.

6. The method of claim 5 wherein the torque includes a twisting torque component and the method further comprises detecting the twisting torque component and modifying the visual display 16 in accordance with a predetermined relationship between the detected twisting torque component and the visual display 16.

7. The method of claim 5 wherein the torque includes a bending torque component and the method further comprises detecting the bending torque component and modifying the visual display 16 in accordance with a predetermined relationship between the detected bending torque component and the visual display 16.

8. The method of claim 5 wherein the torque includes a planar torque component and the method further comprises detecting the planar torque component and modifying the visual display 16 in accordance with a predetermined relationship between the detected planar torque component and the visual display 16.

9. The method of claim 1, wherein the display panel 12 includes a housing 34 and a stowable display screen 32 which may be rolled up into and stowed within a housing 34, with the housing 34 extending along and attached to an edge of the stowable display screen 32, and the method further comprises applying the bending force 18 to the stowable display screen 32.

10. The method of claim 8 wherein the display panel 12 includes a roller 36 attached to the stowable display screen 32 for receiving the stowable display screen 32 as it is rolled up into the housing 34, and the method further comprises:
detecting a reaction on the roller 36 resulting from application of the bending force 18 to the display panel 12; and
modifying the visual display 16 in accordance with a predetermined relationship between the detected reaction on the roller 36 and the visual display 16.

11. The method of claim 10 wherein the reaction on the roller 36, resulting from application of the bending force 18 to the display panel 12, is a torque on the roller 36.

12. An apparatus for controlling a visual display 16 on a display panel 12 by applying a bending force 18 to the display panel 12, the apparatus comprising:
the display panel 12; and
a detector 20 operatively attached to the display panel 12 for detecting the bending force 18 applied to the display panel 12.

13. The apparatus of claim 12 further comprising a controller 22 operatively connected to the detector 20 and the display panel 12 for receiving the detected bending force 18 from the detector 20 and modifying the visual display in accordance with a predetermined relationship between the detected bending force 18 and the visual display 16.

14. The apparatus of claim 13 wherein the display panel 12 includes a control device 30 for modifying the predetermined relationship between the bending force 18 and the visual display 16.

15. The apparatus of claim 13 wherein the display panel 12 includes a control device 30 for receiving an input for modifying the visual display 16 according to a predetermined relationship between the input applied to the control device 30 and the visual display 16, and the controller 22 modifies the predetermined relationship between the input applied to the control device 30 and the visual display 16 in accordance with the bending force 18 applied to the display panel 12.

16. The apparatus of 14 wherein:
application of the bending force 18 to the display panel 12 generates a torque on the display panel 12; and
the controller 22 modifies the visual display 16 in accordance with a predetermined relationship between the torque and the visual display 16.

17. The apparatus of claim 16 wherein the torque includes a twisting torque component and the controller 22 modifies the visual display 16 in accordance with a predetermined relationship between the twisting torque component and the visual display 16.

18. The apparatus of claim 16 wherein the torque includes a bending torque component and the controller 22 modifies the visual display 16 in accordance with a predetermined relationship between the bending torque component and the visual display 16.

19. The apparatus of claim 16 wherein the torque includes a planar torque component and the controller 22 modifies the visual display 16 in accordance with a predetermined relationship between the planar torque component and the visual display 16.

20. The apparatus of claim 12, wherein the display panel 12 comprises:
a housing 34; and
a stowable display screen 32 which may be rolled up into and stowed within the housing 34;
the housing 34 extending along and attached to an edge of the stowable display screen 32

21. The apparatus of claim 20 wherein:
the display panel 12 includes a roller 36 attached to the stowable display screen 32 for receiving the stowable display screen 32 as it is rolled up into the housing;
the detector 20 is operatively connected to the roller 36 for detecting a reaction on the roller 36 resulting from application of the bending force 18 to the display panel 12; and
the controller 22 modifies the visual display 16 in accordance with a predetermined relationship between the detected reaction on the roller 36 and the visual display 16.

22. The apparatus of claim 21 wherein the reaction of the bending force 18 on the roller 36, resulting from application of the bending force 18 to the display panel 12, is a torque on the roller 36.

23. A portable electronic device 10 comprising:
a display panel 12;
a processor 14 for generating a visual display 16 on a display panel 12; and
an apparatus for controlling the visual display 16 on the display panel 12 by applying a bending force 18 to the display panel 12;
the apparatus for controlling the visual display 16 comprising the display panel and a detector 20 operatively attached to the display panel 12 for detecting the bending force 18 applied to the display panel 12.

24. The portable electronic device 10 of claim 23 further comprising a controller 22 operatively connected to the detector 20 and the display panel 12 for receiving the detected bending force 18 from the detector 20 and modifying the visual display 16 in accordance with a predetermined relationship between the detected bending force 18 and the visual display 16.

25. The electronic device 10 of claim 24 wherein:
the visual display 16 includes a movable cursor 28; and
the controller 22 modifies the visual display 16 by moving the cursor 28 in accordance with a predetermined relationship between the detected bending force 18 and the visual display 16.

26. The electronic device 10 of claim 24 wherein:
the visual display 16 is scrollable; and
the controller 22 modifies the visual display 16 by scrolling the visual display 16 in accordance with a predetermined relationship between the detected bending force 18 and the visual display 16.

27. The electronic device 10 of claim 24 wherein:
the visual display 16 includes a pageup/down mode; and
the controller 22 modifies the visual display 16 by paging up/down in accordance with a predetermined relationship between the detected bending force 18 and the visual display 16.
